(19) United States
(12) Patent Application Publication
(10) Pub. No.: US 2023/0318470 A1
(43) Pub. Date: Oct. 5, 2023

(54) Wide-Range Input DC/DC Converter

(71) Applicant: Lear Corporation, Southfield, MI (US)

(72) Inventors: Antonio MARTINEZ PEREZ, Valls (ES); Ruben MOLINA LLORENTE, Valls (ES); Rafael JIMENEZ PINO, Valls (ES); Pablo GAONA ROSANES, Valls (ES); Hector SARNAGO ANDIA, Olvega (ES); Oscar LUCIA GIL, Zaragoza (ES)

(73) Assignee: Lear Corporation, Southfield, MI (US)

(21) Appl. No.: 17/710,313

(22) Filed: Mar. 31, 2022

(51) Int. Cl. H02M 3/335; H02M 3/158; B60L 15/00

(52) U.S. Cl. CPC H02M 3/33584; H02M 3/158; B60L 15/007; B60L 2210/10

(57) ABSTRACT

A DC/DC converter applies a dual active bridge (DAB) topology to convert an input DC voltage into an output DC voltage. The DC/DC converter includes a transformer, a primary stage, and a secondary stage. The primary stage includes an inductor, a first H-bridge arm having first and second power switches connected at a first node therebetween, and a second H-bridge arm having first and second capacitors connected at a second node therebetween. The inductor is connected between the first node and a terminal of an input port of the primary stage. The primary stage receives the input DC voltage at the input port of the primary stage and converts the input DC voltage into a first AC voltage. The transformer transforms the first AC voltage into a second AC voltage. The secondary stage converts the second AC voltage into the output DC voltage.

### TECHNICAL FIELD

The present invention relates to a DC/DC converter for use in an electric vehicle.

### BACKGROUND

A DC/DC converter converts an input DC (direct current) voltage into an output DC voltage. More particularly, a buck DC/DC converter converts an input DC voltage with an input DC current into a lower output DC voltage with a higher output DC current. Conversely, a boost DC/DC converter converts an input DC voltage with an input DC current into a higher output DC voltage with a lower output DC current. A bidirectional DC/DC converter functions as a buck DC/DC converter in one power flow direction and functions as a boost DC/DC converter in an opposite power flow direction.

### SUMMARY

An object includes a DC/DC converter having a dual active bridge (DAB) topology with a pre-boosting stage integrated therein.

Another object includes a DC/DC converter which can convert input DC voltages falling within a range of 100 to 430 V DC (@1-5 kW, for example) into a low-voltage output DC voltage falling within a range of 5 to 48 V DC.

A further object includes a DC/DC converter which can convert input DC voltages falling in a range below 200 V DC for 400 V DC batteries into the low-voltage output DC voltage.

In carrying out at least one of the above and/or other objects, a DC/DC converter that applies a DAB topology to convert an input DC voltage into an output DC voltage is provided. The DC/DC converter includes a transformer, a primary stage, and a secondary stage. The primary stage includes an inductor, a first H-bridge arm having first and second power switches connected at a first node therebetween, and a second H-bridge arm having first and second capacitors connected at a second node therebetween. The inductor is connected between the first node and a terminal of an input port of the primary stage. The primary stage is configured to receive the input DC voltage at the input port of the primary stage and convert the input DC voltage into a first AC voltage. The transformer is configured to transform the first AC voltage into a second AC voltage. The secondary stage is configured to convert the second AC voltage into the output DC voltage.

In embodiments, the first node is a first input terminal of a primary winding of the transformer and the second node is a second input terminal of the primary winding of the transformer. In embodiments, an output of the first power switch is connected to the first node and an input of the second power switch is connected to the first node.

In embodiments, the first and second power switches are MOSFET power switches, and a source of the first power switch is connected to the first node and a drain of the second power switch is connected to the first node.

In embodiments, the DC/DC converter is bidirectional.

In embodiments, the secondary stage includes a switching network. In embodiments, the switching network of the secondary stage is a H-bridge circuit.

In embodiments, the input DC voltage falls within a range of 100 to 430 V DC. In embodiments, the output DC voltage falls within a range of 5 to 48 V DC. In embodiments, the output DC voltage is about 12 V DC.

In embodiments, the input DC voltage is inputted at the input port of the primary stage from an energy source connected to the input port of the primary stage. The energy source may be a traction battery, an on-board battery charger, a regenerative-braking machine, or the like. In embodiments, the output DC voltage is outputted from an output port of the secondary stage to a low-voltage battery connected to the output port of the secondary stage. In embodiments, the output DC voltage is outputted from an output port of the secondary stage to a load in a voltage network.

Further, in carrying out at least one of the above and/or other objects, an assembly having a controller and the DC/DC converter is provided. The controller is configured to control operation of the first and second power switches for the DC/DC converter to convert the input DC voltage into the output DC voltage.

### BRIEF DESCRIPTION OF THE DRAWINGS

FIG. 1 illustrates a block diagram of a DC/DC converter assembly for converting an input DC voltage into an output DC voltage, the DC/DC converter assembly having a first DC/DC converter and a second DC/DC converter connected to one another in a cascade configuration;

FIG. 2 illustrates an electrical schematic diagram of a variant of the DC/DC converter assembly, the DC/DC converter assembly variant having a conventional first DC/DC converter and a second DC/DC converter having a DAB topology; and

FIG. 3 illustrates an electrical schematic diagram of a DC/DC converter in accordance with embodiments of the present invention.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It is recognized that various electrical devices such as controllers as disclosed herein may include various microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, these electrical devices utilize one or more microprocessors to execute a computer-program that is embodied in a non-transitory computer readable medium that is programmed to perform any number of the functions as disclosed. Further, the various electrical devices as provided herein include a housing and various numbers of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The electrical devices also include hardware-based inputs and outputs for receiving and transmitting data, respectively from and to other hardware-based devices as discussed herein.

A DC/DC converter may be on-board an electric vehicle (EV) for use in converting an input DC voltage into an output DC voltage. The terms “electric vehicle” and “EV” herein encompass any type of vehicle which uses electrical power for vehicle propulsion including battery-only electric vehicles (BEV), hybrid electric vehicles (HEV), plug-in hybrid electric vehicles (PHEV), and the like.

An EV includes an energy source such as a traction battery. The traction battery is a high-voltage DC battery (e.g., a 400 V DC battery) that stores electrical energy for powering electric machines of the EV to propel the EV. The EV may further include a low-voltage or electronic system DC battery (“low-voltage battery”). The low-voltage battery (e.g., a 5 to 48 V DC battery) stores electrical energy for powering a low-voltage network of the EV.

In addition to providing electric energy for vehicle propulsion, the traction battery provides electrical energy for charging the low-voltage battery. In this regard, the DC/DC converter on-board the EV is connected between the traction battery and the low-voltage battery. The DC/DC converter is controlled to convert a high-voltage input DC voltage (e.g., 400 V DC input voltage) from the traction battery into a low-voltage output DC voltage (e.g., 5 to 48 V DC output voltage) compatible with the low-voltage battery. Herein, as an example, the low-voltage battery is a 12 V DC battery, and the low-voltage output DC voltage is a 12 V DC output voltage. Alternatively, the low-voltage battery is eliminated, and the DC/DC converter provides the low-voltage output DC voltage to the low-voltage network of the EV.

In operation of a DC/DC converter converting an input voltage from, for example, a 400 V DC traction battery, there is a relatively broad input voltage operating range, for example, 200 to 430 V DC, due to switching of modes of the EV during the conversion by the DC/DC converter. As such, the DC/DC converter has to be capable of being able to convert, in this example, an input DC voltage falling within the range 200 to 430 V DC into the 12 V DC output voltage compatible with the low-voltage battery.

Some DC/DC converters utilize a dual active bridge (DAB) topology for converting input DC voltages into output DC voltages. Certain types of DC/DC converters which utilize a DAB topology are capable of converting input DC voltages falling within the range of 200 to 430 V DC into the 12 V DC output voltage. An issue is that these certain types of DC/DC converters are unable to convert input DC voltages falling within a lower range of about 100 to 200 V DC into the 12 V DC output voltage. This is an issue in that it is desirable for such a DC/DC converter, which can convert input DC voltages falling within the range of 200 to 430 V DC into a 12 V DC output voltage, to be able to convert input DC voltages falling anywhere within the wider range of 100 to 430 V DC (@ 1-5 kW, for example) into the 12 V DC output voltage. Such a wider input DC voltage range is desirable in order to cope with unexpected malfunctions.

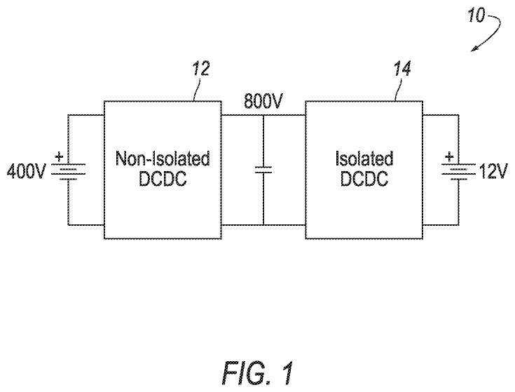

Referring now to FIG. 1, a block diagram of a DC/DC converter assembly 10 is shown. DC/DC converter assembly 10 is capable of converting input DC voltages falling within the wider range of 100 to 430 V DC into the 12 V DC output voltage. DC/DC converter assembly 10 includes a first DC/DC converter 12 and a second DC/DC converter 14. First and second DC/DC converters 12 and 14 are connected to one another in a cascade configuration. Further, as shown in FIG. 1, first DC/DC converter 12 is a non-isolated DC/DC converter whereas second DC/DC converter 14 is an isolated DC/DC converter.

First DC/DC converter 12 functions as a boost DC/DC converter in converting the input DC voltage (for example, 400 V DC input voltage as shown in FIG. 1) into a higher output DC voltage (for example, 800 V DC output voltage as shown in FIG. 1). Second DC/DC converter 14 functions as a buck DC/DC converter in converting the higher output DC voltage into the 12 V DC output voltage. For instance, the 400 V DC input voltage is inputted to DC/DC converter assembly 10 from a traction battery of an EV and the 12 V DC output voltage is outputted from the DC/DC converter assembly to a low-voltage battery of the EV.

DC/DC converter assembly 10 provides a solution for converting input DC voltages falling within the wider range of 100 to 430 V DC (@1-5 kW, for example) into the 12 V DC output voltage. However, DC/DC converter assembly 10 achieves this solution by cascading two DC/DC converters 14 and 16 with first DC/DC converter 14 operating to boost the input DC voltage.

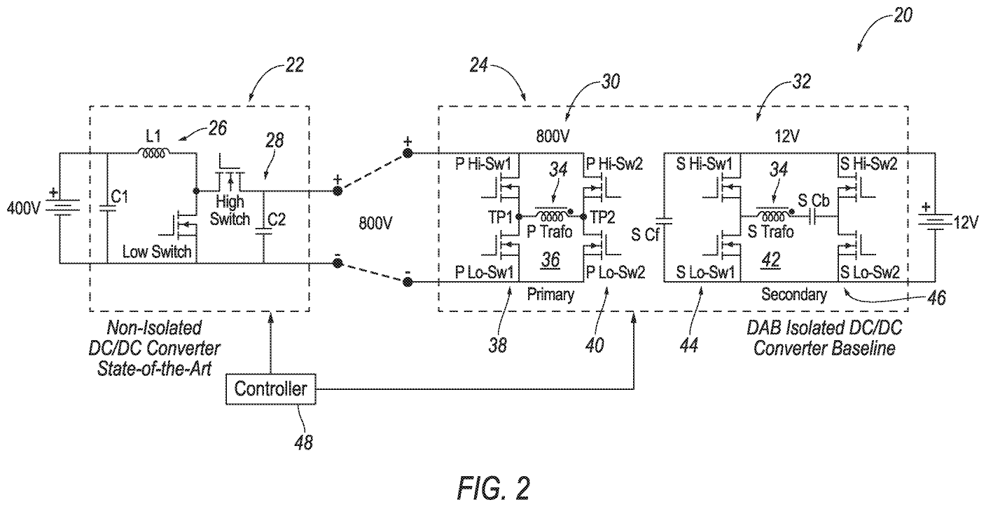

Referring now to FIG. 2, with continual reference to FIG. 1, an electrical schematic diagram of a variant 20 of DC/DC converter assembly 10 is shown. DC/DC converter assembly variant 20 includes a first DC/DC converter 22 and a second DC/DC converter 24. First DC/DC converter 22 is a non-isolated, conventional DC/DC converter. Second DC/DC converter 24 is an isolated, DC/DC converter which utilizes a DAB topology. In this regard, a standalone DAB DC/DC converter like second DC/DC converter 24 is capable of converting input DC voltages falling within the range of 200 to 430 V DC into a 12 V DC output voltage but is not capable of converting input DC voltages falling within the wider range of 100 to 430 V DC into the 12 V DC output voltage. Particularly, DAB second DC/DC converter 24 is not capable of converting input DC voltages falling the sub-range of 100 to 200 V DC into the 12 V DC output voltage.

Conventional first DC/DC converter 22 being cascaded with DAB second DC/DC converter 24 enables DC/DC converter assembly variant 20 to be able to convert input DC voltages falling within the wider range of 100 to 430 V DC into the 12 V DC output voltage.

As shown in FIG. 2, conventional first DC/DC converter 22 includes a switching network 28 and a filter network 26. Switching network 28 includes first and second power switches (labeled “High Switch” and “Low Switch”, respectively, in FIG. 2) connected together at a node. The first and second power switches of switching network 28 are connected between the positive and negative sides of an output port of conventional first DC/DC converter 22. The negative side of the output port of conventional first DC/DC converter 22 is connected to the negative side of an input port of the conventional first DC/DC converter. The positive and negative terminals of the traction battery are connected to the positive and negative sides of the input voltage bus for the traction battery to be connected to the input port of conventional first DC/DC converter 22 and thereby be connected to DC/DC converter assembly variant 20. Filter network 26 is an LC filter network that includes an inductor and a capacitor connected together at another node. Filter network 26 is connected between the node at which first and second power switches of switching network 28 are connected and the negative side of the input port of conventional first DC/DC converter 22. The node at which the inductor and capacitor of filter network 26 are connected is connected to the positive side of the input port of conventional first DC/DC converter 22.

As shown in FIG. 2, consistent with FIG. 1, conventional first DC/DC converter 22 functions as a boost DC/DC converter in converting an input voltage (i.e., the exemplary 400 V DC input voltage), which is inputted at the input port of the conventional first DC/DC converter, into a higher output voltage (i.e., the exemplary higher 800 V DC output voltage), which is outputted at the output port of the conventional first DC/DC converter.

As further shown in FIG. 2, DAB second DC/DC converter 24 includes a DAB topology. In this regard, DAB second DC/DC converter 24 includes a primary stage 30, a secondary stage 32, and a transformer 34. Primary stage 30 receives as an input voltage the output voltage (i.e., the exemplary higher 800 V DC output voltage) outputted at the output port of conventional first DC/DC converter 22. Primary stage 30 converts the exemplary higher 800 V DC output voltage into a first AC (alternating current) voltage and outputs the first AC voltage to transformer 34. Transformer 34 transforms the first AC voltage into a second AC voltage. Secondary stage 32 receives the second AC voltage from transformer 34 and converts the second AC voltage into the output voltage (i.e., the 12 V DC output voltage) of DC/DC converter assembly variant 20.

In further detail, primary stage 30 includes a first switching network 36 having a first set of four power switches. For example, these power switches are MOSFETs as indicated in FIG. 2. First switching network 36 is an H-bridge switching network having a first H-bridge arm 38 that includes first and second ones of the first set of power switches and a second H-bridge arm 40 that includes third and fourth ones of the first set of power switches.

In first H-bridge arm 38, the source of first power switch P Hi-Sw1 is connected to a first input terminal Tp1 of primary windings of transformer 34 and the drain of first power switch P Hi-Sw1 is connected to the positive side of the output port of conventional first DC/DC converter 22. The source of first power switch P Hi-Sw1 is also connected to the drain of second power switch P Lo-Sw1. Therefore, both the source of first power switch P Hi-Sw1 and the drain of second power switch P Lo-Sw1 are connected to the first input terminal Tp1 of primary windings of transformer 34. The source of second power switch P Lo-Sw1 is connected to the negative side of the output port of conventional first DC/DC converter 22.

Similarly, in second H-bridge arm 40, the source of third power switch P Hi-Sw2 is connected to a second input terminal Tp2 of primary windings of transformer 34 and the drain of third power switch P Hi-Sw2 is connected to the positive side of the output port of conventional first DC/DC converter 22. The source of third power switch P Hi-Sw2 is also connected to the drain of fourth power switch P Lo-Sw2. Therefore, both the source of third power switch P Hi-Sw2 and the drain of fourth power switch P Lo-Sw2 are connected to the second input terminal Tp2 of primary windings of transformer 34. The source of fourth power switch P Lo-Sw2 is connected to the negative side of the output port of conventional first DC/DC converter 22.

In further detail, secondary stage 32 includes a second switching network 42 having a second set of four power switches. Second switching network 42 is an H-bridge switching network having a third H-bridge arm 44 that includes first and second ones of the second set of power switches and a fourth H-bridge arm 46 that includes third and fourth ones of the second set of power switches. For example, these power switches are MOSFETs as indicated in FIG. 2.

In unidirectional embodiments, second switching network 42 may be an H-bridge network of diodes.

During operation when primary stage 30 receives the higher output voltage from conventional first DC/DC converter 22, first switching network 36 of the primary stage establishes the first AC voltage that is applied to transformer 34 by creating positive and negative voltages that are alternatively applied to first and second input terminals Tp1 and Tp2 of primary windings of transformer 34. Transformer 34 transforms the first AC voltage into the second AC voltage. During operation when secondary stage 32 receives the second AC voltage, second switching network 42 of the secondary stage is operated to convert the second AC voltage into the output voltage (i.e., the 12 V DC output voltage) of DC/DC converter assembly variant 20. Secondary stage 32 thus functions as a secondary side conversion circuit for converting the second AC voltage into the output voltage.

As described, DAB second DC/DC converter 24 includes an inverter module in the form of primary stage 30, a transformer module including transformer 34, and a rectifier module in the form of secondary stage 32. The inverter module includes a high-voltage bridge of power switches. The rectifier module includes a low-voltage bridge of power switches or, in other embodiments, a low-voltage bridge of diodes. The transformer module includes a transformer having a primary side connected to the high-voltage bridge of the inverter module and a secondary side connected to the low-voltage bridge of the rectifier module. Of course, the “inverter” and the “rectifier” are reversed when the voltage conversion is reversed.

Further, as shown in FIG. 2, a controller 48 is associated with each of conventional first DC/DC converter 22 and DAB second DC/DC converter 24. Controller 48 is configured to control the operation of the power switches of conventional first DC/DC converter 22 for the conventional first DC/DC converter to convert an input DC voltage into the higher output DC voltage. Controller 38 is configured to control the operation of the power switches of first and second switching networks 36 and 42 of primary and secondary stages 30 and 32 of DAB second DC/DC converter 24 for the DAB second DC/DC converter to convert the higher output DC voltage into the low-voltage DC output voltage. For instance, controller 48 controls the power switches by providing appropriate pulse-width modulated (PWM) control signals to the power switches. In sum, controller 48 is operable to turn on and off the power switches at selected interval rates (i.e., selectively activates/deactivates the power switches) for DC/DC converter assembly variant 20 to convert an input DC voltage falling within the wider range of 100 to 430 V DC into the 12 V DC output voltage.

As set forth, DC/DC converter assembly variant 20 includes two separate converters. Namely, DC/DC converter assembly variant 20 includes conventional first DC/DC converter 22 and DAB second DC/DC converter 24. Conventional first DC/DC converter 22 boosts input voltages including input voltages lower than 200 V DC. DAB second DC/DC converter 24 provides the high to low DC voltage conversion. As such, DC/DC converter assembly variant 20 includes a boosting stage in the form of conventional first DC/DC converter 22 and a high-to-low voltage conversion stage in the form of DAB second DC/DC converter 24.

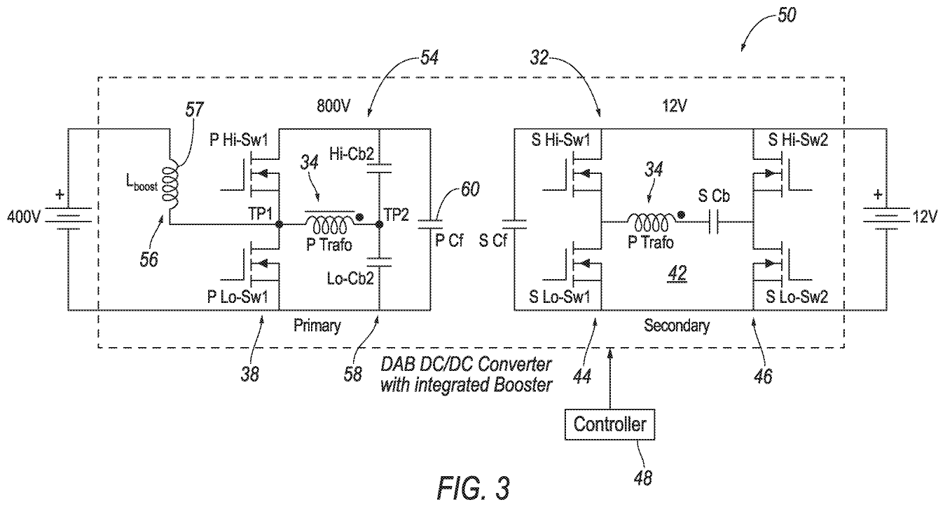

Referring now to FIG. 3, with continual reference to FIGS. 1 and 2, an electrical schematic diagram of a DC/DC converter 50 in accordance with embodiments of the present invention is shown. DC/DC converter 50 is capable of converting input DC voltages falling within the wider range of 100 to 430 V DC into the 12 V DC output voltage.

As shown in FIG. 3, DC/DC converter 50 is characterized as being one DC/DC converter. Thus, DC/DC converter 50 is a single converter whereas DC/DC converter assembly 10 shown in FIG. 1 and DC/DC converter assembly variant 20 shown in FIG. 2 each include two DC/DC converters.

DC/DC converter 50 is formed by integrating a first DC/DC converter functioning as a boosting stage with a DAB second DC/DC converter functioning as a high-to-low voltage conversion stage such that the primary stage of the DAB second DC/DC converter includes input voltage boosting. For example, in comparison with DC/DC converter assembly variant 20 shown in FIG. 2, DC/DC converter 50 may be formed by integrating first DC/DC converter 22 with DAB second DC/DC converter 24 such that primary stage 30 of the DAB second DC/DC converter includes input voltage boosting. As such, in this example, DC/DC converter 50 is DAB second DC/DC converter 24 with a pre-boosting stage integrated therein. Particularly, the pre-boosting stage is integrated in primary stage 30 of DAB second DC/DC converter 20.

As set forth, DC/DC converter 50 is a DAB DC/DC converter with an integrated booster. In being a DAB DC/DC converter, DC/DC converter 50 includes a primary stage 54, secondary stage 32, and transformer 34. In being a DAB DC/DC converter with an integrated booster, (i) primary stage 54 includes a pre-boosting stage 56 and (ii) the second H-bridge arm of primary stage 54 includes first and second capacitors in place of power switches.

Pre-boosting stage 56 includes an inductor 57 connected between the positive side of the input voltage bus and the first input terminal Tp1 of primary windings of transformer 34. Inductor 57 of pre-boosting stage 56 is thus connected between the positive terminal of a traction battery connected to the input port of DC/DC converter 50 and the first input terminal Tp1 of primary windings of transformer 34.

Primary stage 54 has an H-bridge architecture including a switching network having first and second power switches connected together at a first node and a capacitor network having first and second capacitors connected together at a second node. The H-bridge architecture of primary stage 54 includes a first H-bridge arm 38 having the first and second power switches. However, as part of the incorporation of pre-boosting stage 56, the H-bridge architecture of primary stage 54 includes a second H-bridge arm 58 having the first and second capacitors. An additional capacitor 60 is connected in parallel to the first and second capacitors of second H-bridge arm 58. In comparison, with reference to FIG. 2, second H-bridge arm 40 of DAB second DC/DC converter 24 includes third and fourth power switches.

Pre-boosting stage 56 thus represents a non-isolated, boost DC/DC stage functionality that is integrated into primary stage 30 of DAB second DC/DC converter 24 to thereby form DC/DC converter 50. Pre-boosting stage 56 increases the range of input voltage handling capacity whereby DC/DC converter 50 can accommodate the wider input voltage range of 100 to 430 V DC in converting an input DC voltage into a low output DC voltage as opposed to just being able to accommodate the ordinary input voltage range of 200 to 430 V DC. As DC/DC converter 50 is a single converter, the cost, weight, and size are relatively reduced while efficiency is relatively increased.

Controller 48 is associated with DC/DC converter 50. Controller 48 is configured to control the operation of the first and second power switches of primary stage 54 of DC/DC converter 50 and the operation of the power switches of secondary stage 32 of DC/DC converter 50 for DC/DC converter 50 to convert an input DC voltage falling within the wider range of 100 to 430 V DC into the 12 V DC output voltage.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A DC/DC converter that applies a dual active bridge (DAB) topology to convert an input DC voltage into an output DC voltage, the DC/DC converter comprising:
a transformer;
a primary stage including an inductor, a first H-bridge arm having first and second power switches connected at a first node therebetween, and a second H-bridge arm having first and second capacitors connected at a second node therebetween, the inductor being connected between the first node and a terminal of an input port of the primary stage;
the primary stage being configured to receive the input DC voltage at the input port of the primary stage and convert the input DC voltage into a first AC voltage;
the transformer being configured to transform the first AC voltage into a second AC voltage; and
a secondary stage configured to convert the second AC voltage into the output DC voltage.

2. The DC/DC converter of claim 1 wherein:
the first node is a first input terminal of a primary winding of the transformer and the second node is a second input terminal of the primary winding of the transformer.

3. The DC/DC converter of claim 2 wherein:
an output of the first power switch is connected to the first node and an input of the second power switch is connected to the first node.

4. The DC/DC converter of claim 1 wherein:
the first and second power switches are MOSFET power switches; and
a source of the first power switch is connected to the first node and a drain of the second power switch is connected to the first node.

5. The DC/DC converter of claim 1 wherein:
the DC/DC converter is bidirectional.

6. The DC/DC converter of claim 1 wherein:
the secondary stage includes a switching network.

7. The DC/DC converter of claim 6 wherein:
the switching network of the secondary stage is a H-bridge circuit.

8. The DC/DC converter of claim 1 wherein:
the input DC voltage falls within a range of 100 to 430 V DC.

9. The DC/DC converter of claim 8 wherein:
the output DC voltage falls within a range of 5 to 48 V DC.

10. The DC/DC converter of claim 1 wherein:
the input DC voltage is inputted at the input port of the primary stage from an energy source connected to the input port of the primary stage.

11. The DC/DC converter of claim 10 wherein:
the output DC voltage is outputted from an output port of the secondary stage to a low-voltage battery connected to the output port of the secondary stage.

12. The DC/DC converter of claim 10 wherein:
the output DC voltage is outputted from an output port of the secondary stage to a load in a voltage network.

13. An assembly comprising:
a controller; and
a DC/DC converter that applies a dual active bridge (DAB) topology to convert an input DC voltage into an output DC voltage, the DC/DC converter including a transformer, a primary stage, and a secondary stage, wherein the primary stage include an inductor, a first H-bridge arm having first and second power switches connected at a first node therebetween, and a second H-bridge arm having first and second capacitors connected at a second node therebetween, the inductor being connected between the first node and a terminal of an input port of the primary stage, the primary stage being configured to receive the input DC voltage at the input port of the primary stage and convert the input DC voltage into a first AC voltage, the transformer being configured to transform the first AC voltage into a second AC voltage, and the secondary stage configured to convert the second AC voltage into the output DC voltage; and
the controller being configured to control operation of the first and second power switches for the DC/DC converter to convert the input DC voltage into the output DC voltage.

14. The assembly of claim 13 wherein:
the input DC voltage falls within a range of 100 to 430 V DC.

15. The assembly of claim 13 wherein:
the DC/DC converter is bidirectional.

16. The assembly of claim 13 wherein:
the input DC voltage is inputted at the input port of the primary stage from an energy source connected to the input port of the primary stage.

17. The assembly of claim 16 wherein:
the output DC voltage is outputted from an output port of the secondary stage to a low-voltage battery connected to the output port of the secondary stage.

18. The assembly of claim 16 wherein:
the output DC voltage is outputted from an output port of the secondary stage to a load in a voltage network.
